(19) United States
(12) Patent Application Publication
(10) Pub. No.: US 2004/0044442 A1
(43) Pub. Date: Mar. 4, 2004

(54) Optimized dispatch planning of distributed resources in electrical power systems

(76) Inventors: Deia Salah-Eldin Bayoumi, Fuquay Varina, NC (US); Danny E. Julian, Willow Spring, NC (US); Edward M. Petrie, Cary, NC (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/040,407

(22) Filed: Dec. 28, 2001

(51) Int. Cl. G05D 7/00

(52) U.S. Cl. 700/286

(57) ABSTRACT

An optimized dispatch plan generator for generating an optimized dispatch plan for distributed resources in electrical power systems is based on economic and engineering considerations. The dispatch plan generator comprises several subsystems preferably including an energy management subsystem, an energy trading subsystem, an asset management subsystem, a reliability subsystem and a network analysis subsystem integrated with multiple artificial intelligence agents in one embodiment and with a module employing probabilistic techniques in another embodiment. The dispatch plan generator generates one or more solutions identifying the optimal mix and use of distributed resources and also generates a set of reports and graphs for the optimized solution plan.

### FIELD OF THE INVENTION

This invention relates to the field of computing and in particular to the field of distributed resources in electrical power systems.

### BACKGROUND

Traditionally, electrical power has been produced by large centralized power stations that generate electricity and transmit the electricity over high-voltage transmission lines. The voltage is then stepped-down in several stages and distributed to the customer. Electrical power distribution systems have been evolving due to drawbacks in the generation of power by large centralized power stations, to changes in the regulation of the electrical industry and due to technological advances in the development of different types of small power generators and storage devices.

The bulk of today's electric power comes from central power plants, most of which use large, fossil-fired combination or nuclear boilers to produce steam that drives steam turbine generators. There are numerous disadvantages to these traditional power plants.

Most of these plants have outputs of more than 100 megawatts (MW), making them not only physically large but also complex in terms of the facilities they require. Site selection and procurement are often a real challenge because of this. Often no sites are available in the area in which the plant is needed, or ordinances are in effect (such as no high voltage power lines are permitted in certain areas) that make acquisition of an appropriate site difficult.

There is considerable public resistance on aesthetic, health and safety grounds, to building more large centralized power plants, especially nuclear and traditional fossil-fueled plants. High voltage transmission lines are very unpopular. People object to the building of large power plants on environmental grounds as well. Long distance electricity transmission via high voltage power lines has considerable environmental impact.

Long distance transmission of electricity is expensive, representing a major cost to the end-user because of investment required in the infrastructure and because losses accrue in the long distance transmission of electricity proportionate to the distance traveled so that additional electricity must be generated over that needed to handle the power needs of the area.

Plant efficiency of older, existing large power plants is low. The plant efficiency of large central generation units can be in the 28-35% range, depending on the age of the plant. This means that the plant converts only between 28-35% of the energy in their fuel into useful electric power. To exacerbate the matter, typical large central plants must be over-designed to allow for future capacity, and consequently these large central plants run for most of their life in a very inefficient manner.

In areas where demand has expanded beyond the capacity of large power plants, upgrading of existing power plants may be required if the plant is to provide the needed additional power. This is often an expensive and inefficient process.

Some areas are too remote to receive electricity from existing transmission lines, requiring extension of existing transmission lines, resulting in a corresponding increased cost for electric power.

In part due to concerns regarding centralized power production, the enactment of the Public Utility Regulatory Policies Act of 1978 (PURPA) encouraged the commercial use of decentralized, small-scale power production. PURPA's primary objective was to encourage improvements in energy efficiency through the expanded use of cogeneration and by creating a market for electricity produced from unconventional sources. The 1992 Federal Energy Policy Act served to enhance competition in the electric energy sector by providing open access to the Unites States' electricity transmission network, called the “grid.”

Distributed power generation and storage could provide an alternative to the way utilities and consumers supply electricity which would enable electricity providers to minimize investment, improve reliability and efficiency, and lower costs. Distributed resources can enable the placement of energy generation and storage as close to the point of consumption as possible, with increased conversion efficiency and decreased environmental impact. Small plants can be installed quickly and built close to where the electric demand is greatest. In many cases, no additional transmission lines are needed. A distributed generation unit does not carry a high transmission and distribution cost burden because it can be sited close to where electricity is used, resulting in savings to the end-user.

New technologies concerning small-scale power generators and storage units also have been a force contributing to an impetus for change in the electrical power industry. A market for distributed power generation is developing. The Distributed Power Coalition of America estimates that small-scale projects could capture twenty percent of new generating capacity (35 Gigawatts) in the next twenty years.

Distributed generation is any small-scale power generation technology that provides electric power at a site closer to customers than central station generation. The small-scale power generators may be interconnected to the distribution system (the grid) or may be connected directly to a customer's facilities. Technologies include gas turbines, photovoltaics, wind turbines, engine generators and fuel cells. These small (5 to 1,500 kilowatt) generators are now at the early commercial or field prototype stage. In addition to distributed generation, distributed resources include distributed storage systems such as the storage of energy by small-scale energy storage devices including batteries, super-conducting magnetic energy storage (SMES), and flywheels.

Efficiency of power production of the new small generators is far better than traditional existing power plants. In contrast to the 28-35% efficiency rate of older, centralized large power plants, efficiencies of 40 to 50% are attributed to small fuel cells and to various new gas turbines and combined cycle units suitable for distributed generation applications. For certain novel technologies, such as a fuel cell/gas turbine hybrid, electrical efficiencies of about 70% are claimed. Cogeneration, providing both electricity and heat or cooling at the same time, improves the overall efficiency of the installation even further, up to 90%.

Project sponsors benefit by being able to use electric power generated by distributed resources to avoid high demand charges during peak periods and gain opportunities to profit from selling excess power to the grid. Utilities gain reliability benefits from the additional capacity generated by the distributed resources, and end-users are not burdened with the capital costs of additional generation. In some cases, electricity generated by distributed resources is less costly than electricity from a large centralized power plant.

Hence, the need for the use of distributed resources is increasing tremendously. Typically automated tools that take into consideration both economic and engineering factors been not been available to determine optimal dispatch scenarios for distributed resources. It would be helpful if there were a tool available that could help determine the optimal mix of distributed resources and the way those distributed resources are used, with regard to both economic and engineering considerations.

### SUMMARY OF THE INVENTION

A system and method for generating an optimized dispatch plan for distributed resources in electrical power systems based on economic and engineering considerations is disclosed. The dispatch plan generator comprises several subsystems preferably including an energy management subsystem, an energy trading subsystem, an asset management subsystem, a reliability subsystem and a network analysis subsystem integrated with multiple artificial intelligence agents in one embodiment and with a module employing probabilistic techniques in another embodiment. The dispatch plan generator generates one or more solutions identifying the optimal mix and use of distributed resources and also generates a set of reports and graphs.

The foregoing and other aspects of the present invention will become apparent from the following detailed description of the invention when considered in conjunction with the accompanying drawings.

### BRIEF DESCRIPTION OF THE DRAWINGS

For the purpose of illustrating the invention, there is shown in the drawings exemplary constructions of the invention; however, the invention is not limited to the specific methods and instrumentalities disclosed. In the drawings:

FIG. 1 is a block diagram of a distributed power generation system, as is known in the art;

FIG. 2 is a block diagram of a optimized dispatch plan generator in accordance with the invention;

FIG. 3 is a block diagram of an energy management subsystem in accordance with the invention;

FIG. 4 is a block diagram of an energy trading subsystem in accordance with the invention;

FIG. 5 is a block diagram of an asset management subsystem in accordance with the invention;

FIG. 6 is a block diagram of a reliability subsystem in accordance with the invention;

FIG. 7 is a block diagram of a network analysis subsystem in accordance with the invention;

FIG. 8 is a block diagram of a portion of a dispatch plan generator in accordance with the invention;

FIG. 9 is a flow diagram of a dispatch plan generator in accordance with the invention;

FIG. 10 illustrates an exemplary computing system in accordance with the invention; and

FIG. 11 illustrates an exemplary network environment in accordance with the invention.

### DETAILED DESCRIPTION OF THE INVENTION

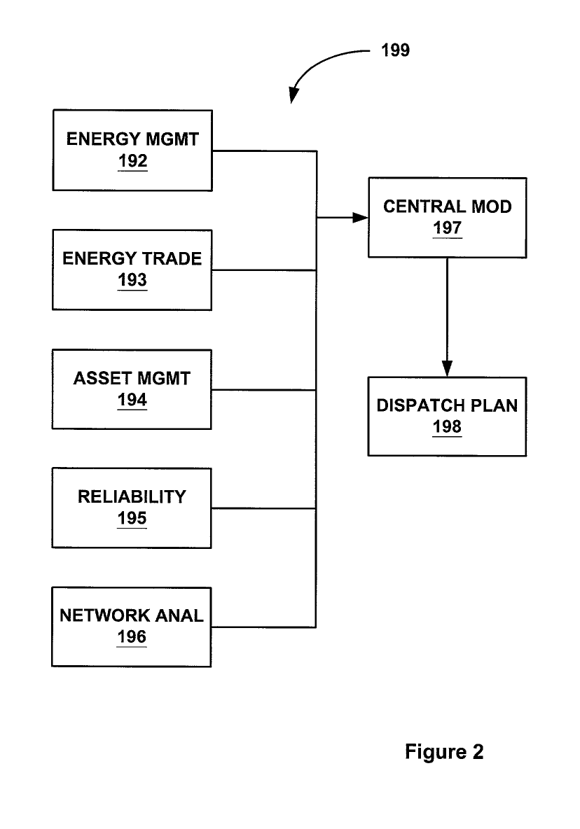

The present invention discloses a system and method to generate an optimized dispatch plan for distributed resources in an electrical power system. FIG. 2 illustrates an optimized dispatch plan generator 199 in accordance with the invention. A plurality of subsystems, (e.g., subsystems 192, 193, 194, 195, and 196) are integrated with a central module 197 that generates a plan 198 for an optimized dispatch of distributed resources. The subsystems 192, 193, 194, 195, and 196 include an energy management (economic) module 192, an energy trading (economic) module 193, an asset management (engineering) module 194, a reliability (engineering) module 195 and a network analysis (engineering) module 196 integrated with a central module 197. Central module 197 may comprise artificial intelligence agents in one embodiment to produce a plan or plans 198 for optimal dispatch of distributed resources. Alternatively, the modules may be integrated with a module that employs probabilistic techniques to generate a plan or plans 198 for optimal dispatch of distributed resources. The probabilistic module or artificial intelligence agents recommend optimal solutions for the distributed resources (e.g., times of operations and percentages of types of units.) The desired solution is determined by user input or alternatively by consulting a predefined set of rules and constraints. After a plan has been selected, reports and graphs are produced.

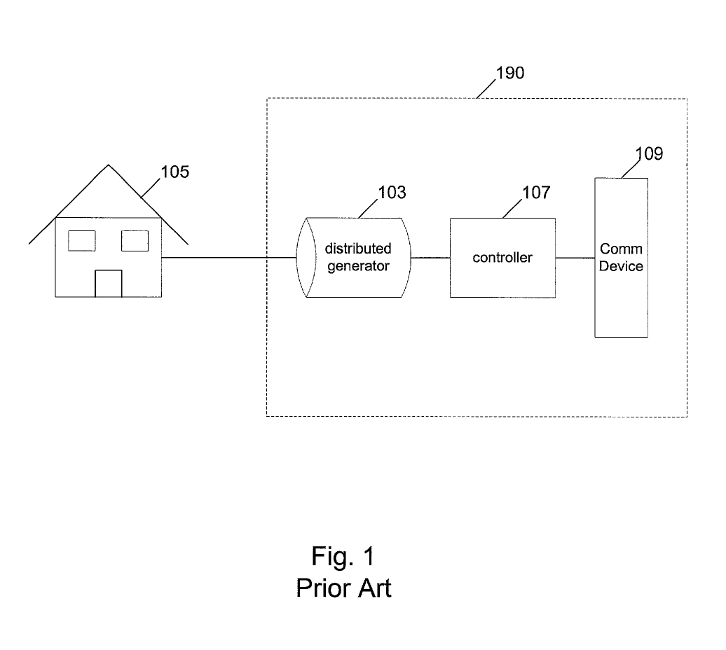

As can be seen from FIG. 1, distributed generation is any small-scale power generation technology such as a distributed resource 103 that provides electric power at a site closer to customers' premises 105 than central station generation. The small-scale power resource 103 (in FIG. 1 distributed resource 103 is a distributed generator but power resource 103 may as well be a storage device), may be interconnected to the distribution system, “the grid” (not shown) and/or may be connected directly to a customer's premise or facility 105. To control a distributed resource 103, distributed resource 103 is connected to a controller 107, such as a conventional programmable logic controller (PLC). Controller 107 may be connected to a communications device 109 such as a modem. A distributed resource power station 190 comprises a distributed resource 103, a controller 107 and a communications device 109.

An electrical power station can include a single power generator, as illustrated in power station 190, or a plurality of power generators (not shown). An electric power station can include a single energy storage unit or a plurality of storage units (not shown). An electric power station (not shown) may include no power storage units. Power stations may be distributed over a geographical region or be located in one area.

The present invention presents an approach for planning the use and type of distributed resources to run in an electrical power system by integrating results from multiple subsystems, described herein. The subsystems may also be accessed in a stand-alone manner, or may be integrated within a dispatching system running within a central control environment, local control environment, or hybrid control environment (described more fully in co-pending U.S. patent application Attorney's Docket No. ABTT-0265, entitled “On-Line Control of Distributed Resources with Different Dispatching Levels”, filed Dec. 28, 2001 and hereby incorporated by reference) as well as being integrated with a module for planning the optimal use of distributed resources. If employed as a stand-alone system, the modules may be initiated by user demand, periodically, or initiation may be triggered by an event. Similarly, if integrated within a central control environment, local control environment or hybrid environment, the subsystems may be initiated by user demand, periodically, or initiation may be triggered by an event.

Energy Management Subsystem

The energy management subsystem 192 preferably provides the cost of operating the distributed resource or resources and interfaces with a billing system. The energy management subsystem preferably determines the total operational costs, and profit or loss associated with the operation of the distributed resource or resources, determines and separates billing information into accounts, and integrates with existing billing systems.

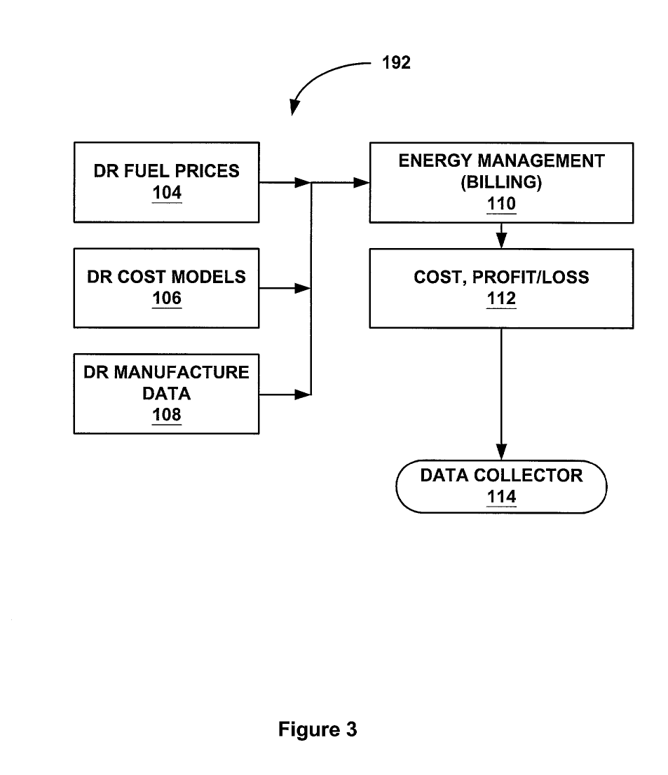

FIG. 3 illustrates an embodiment of the energy management subsystem in accordance with one embodiment of the invention. Inputs to the energy management module 110 include but are not limited to; fuel prices 104 for the distributed resources; distributed resource cost models data 106 and manufacturer's data 108 for the distributed resource. Additional inputs may include but are not limited to maintenance costs for the distributed resources and the total run time (hours of operation) of the distributed resource or resources in the time period for which the energy management system is run. Fuel prices 104 in one embodiment are received from on-line sources such as but not limited to the Internet or the World Wide Web. Alternatively fuel prices may be projected from historical data stored in a database (not shown).

Distributed resources cost models 106 and manufacturer data 108 may be utilized for calculating the distributed resources devices operational costs and electrical and thermal outputs. It is desirable to model distributed resources in detail beyond the typical simplified kW/kVAR and negative load representations cost models. Examples of distributed resources include but are not limited to diesel generators, natural gas reciprocating engines, micro-turbines, thermal-solar plants, photo-voltaic modules, wind turbines, batteries and fuel cells. Preferably any new device that can be installed may also be modeled.

For reciprocating engine generators, data for cost modeling preferably includes but is not limited to the rated power of the reciprocating engine, minimum allowed power, no-load fuel consumption, full-load fuel consumption, capital cost (device, overhaul, operation and maintenance), overhaul period, operational lifetime, and fuel price.

The data necessary for photo-voltaic (PV) modules or cells preferably includes the clearness index of the site, the latitude, the daily (typically an average) radiation or insolation, the module operating temperature, the short circuit current, the open circuit voltage, the maximum power point voltage, the maximum power point current, the number of cells in series, the number of cells in parallel, the module area, the current temperature coefficient, the voltage temperature coefficient, the ambient temperature of the site, the array efficiency, the capital cost (module rack, tracking module, rectifier, inverter, installation), the operational lifetime, the type of tracking and the array slope.

Wind turbine cost modeling data preferably includes rated power, hub height, average interval for power, capital cost (tower, installation, overhaul, operation, maintenance), the overhaul time period, the average wind speed, the wind power scaling factor, the wind turbine spacing, the wind power response, the Weibull coefficient, the diurnal pattern strength and the hour of peak wind speed.

Battery models are dependent on the constant current discharge rate of each type of battery, the beginning (e.g., 20% charged) and end (e.g., 80% charged) of the charging cycle voltages, the depth of discharge versus cycles to failure curve, the cycle life, the float life, the round trip efficiency, the minimum state of charge, the charge rate, nominal voltage, nominal capacity, capacity ratio, rate constant, capital costs (device and operation and maintenance) and the internal resistance.

Fuel cells typically are classified by output power (continuous and peak), and by capital costs (device, inverter, fuel, water, operation and maintenance). Other information may not be available as this technology is not yet mature, however it should be understood that as additional information becomes available, the present invention contemplates the use thereof.

Micro-turbines cost modeling data preferably includes rated power, minimum allowed fuel consumption, capital cost (device, fuel, overhaul, operation and maintenance), operational lifetime, and fuel price.

Detailed models of distributed resources (turbines, combustion engines/turbines, photovoltaics, wind generators, etc.) typically are available from the manufacturers of such devices. If weather information is required (e.g., weather data for particular site at which a photo-voltaic cell is operated), this information may be obtained, in one embodiment, from on-line sources, such as but not limited to the Internet and the World Wide Web. Alternatively, weather information may be projected from one or more historical database sources.

Collecting data concerning costs associated with the operation of distributed resources typically is a difficult task, as there are more than 50 regulatory bodies to consult for data such as interconnection standards and costs, tariff structures, land use costs, environmental costs, and the like. Additionally, although costs are typically set by regulatory bodies, costs are somewhat open to negotiation. A large energy provider may have the political clout to request changes in the regulated costs and thus impact return on investment, whereas a new player in the distributed resources market may have practically no clout. Preferably, the energy trading and energy management subsystem algorithms account for these variables.

The cost of electricity delivered, on a state-by-state basis, including publicly-available tariff schedules preferably is included, as well as entries of service fees, communications costs, billing costs, and the like. For example, if the distributed resource is located on a rented site, land use fees may apply.

Fuel prices 104 may include prices for diesel fuel, natural gas, gasoline and propane and the like. Data associated with distributed resources concerning quantity of fuel use, stored amount, availability and sureness of supply preferably is included.

Operation and maintenance costs of the distributed resource or resources can be on a price per unit of energy basis, price per unit of time basis, price per service basis, and emergency trip basis.

The cost of communication preferably is included, whether fixed land-line, microwave, fiber-optic or other technology. Probability of failure is preferably included to ensure that adequate communication structures are constructed to assure the performance of the DR under all operating conditions (normal, stressed, emergency, outage). If two-way communication is desired, cost will be influenced because of the use of redundant circuits.

Power quality issues such as voltage sags (or dips) and harmonics (from switching or power electronics operations) form another portion of a good power system analysis. The cost of poor power delivery is desirably accounted for, as well as the cost of voltage support devices such as capacitor banks, protective relays, and harmonic filters.

Outputs from the energy management module 110 preferably include the cost of running the distributed resource and the associated profit and loss for the site, unit and for the total distributed system 112. Results from the energy management module 110 may be sent to a data collector 114 and may additionally be stored in a database (not shown). Alternately, the results may be sent to a user or to a dispatching system.

For example, assume a user owns one or a number of distributed resources that can produce 10 MW of power and the units supply power to three different sites during the period of one month. Assume further that the distributed resources run for 200 hours during the one-month period. Preferably, the energy management system interfaces with the distributed resources owner's existing billing software and invoices each of the three sites for the power each site received. The energy management subsystem may also determine the cost of running the 10 MW distributed resource, and the profit or loss realized as a result of running the distributed resources instead of getting the power from the grid.

As another example, assume a user has a plurality of distributed resource units, where the units include different technologies (i.e., one unit is a wind turbine, two units are fuel cells and three units are microturbines). Preferably the present invention analyzes the model data and location data for each unit and generates an optimized mix of unit dispatch, providing the most profitable operation to the user, taking into consideration network stability. The dispatch plan may comprise for example:

“Run units one and three from 9 am to 3 pm and run units two, and four through six from 2 pm to 10 pm.”

For a user who is a utility, the present invention preferably helps dispatch which units should be run at what level to help stabilize the system, as well as filling the power needs of the network. The network analysis subsystem preferably suggests many scenarios to solve any current situation the utility user may face at a particular point in time. Preferably the present invention is able to detect what units are available, at what cost and compare this information with current energy prices to determine the most profitable solution.

Energy Trading Subsystem

The energy trading subsystem 193 facilitates the process of allowing the distributed resources owner to trade electrical capacity. The energy trading subsystem 193 preferably enables a user to sell to or buy capacity from the electric futures market. The energy trading subsystem 193 also determines whether it would be profitable for the user to sell to or buy from the electric futures market at the time the subsystem is accessed. The energy trading subsystem 193 also enables the user to capture a record of an executed energy trading transaction.

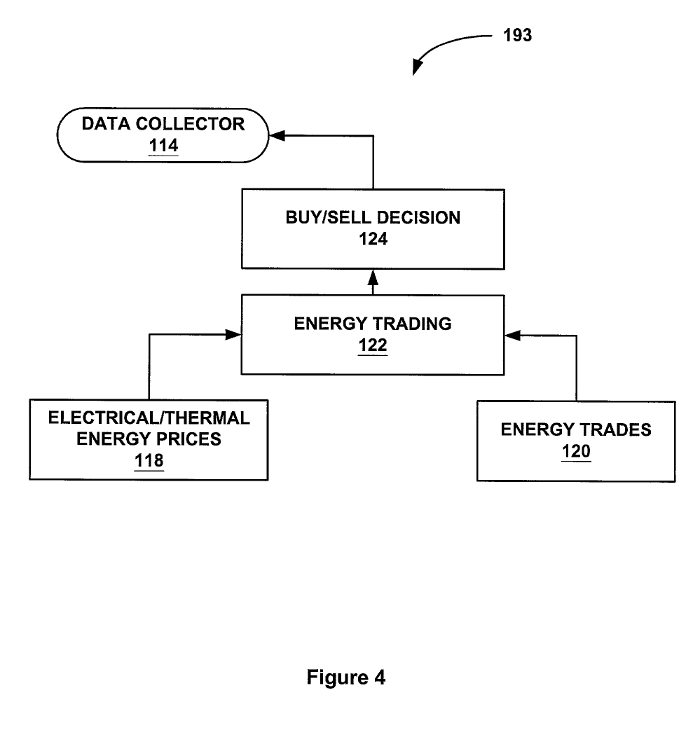

FIG. 4 illustrates an energy trading subsystem 193 in accordance with the present invention.

Inputs to the energy trading module 122 include but are not limited to energy trades 120, and electrical and thermal energy prices 118. Additional inputs may include a forecasted load profile (not shown). Information concerning energy trades 120 and electrical and thermal energy prices 118 may be received from online sources including but not limited to the Internet and World Wide Web or alternatively may be projected from historical data stored in one or more databases.

Outputs include but are not limited to a buy/sell recommendation 124 and profit or loss realized from an executed buy/sell decision (not shown). Results from energy trading subsystem may be sent to data collector 114. Alternately, the results may be sent to a user or to a dispatching system.

For example, assume a user owns a distributed resource or resources capable of producing 10 MW. The energy trading subsystem may provide a recommendation that the user should sell the power supplied by the distributed resources to the grid. If the user determines that the energy should be sold, the energy trading subsystem may make the trade and record the transaction.

Asset Management Subsystem

The asset management subsystem 194 tracks operational issues associated with the distributed resources devices. The asset management subsystem 194 preferably determines when maintenance of a distributed resource or resources is needed or recommended and generates notifications thereof. The asset management system 194 preferably also tracks the operational efficiency and reliability of the distributed resource or resources. Preferably, the asset management system 194 also provides notification when a distributed resource fails to operate.

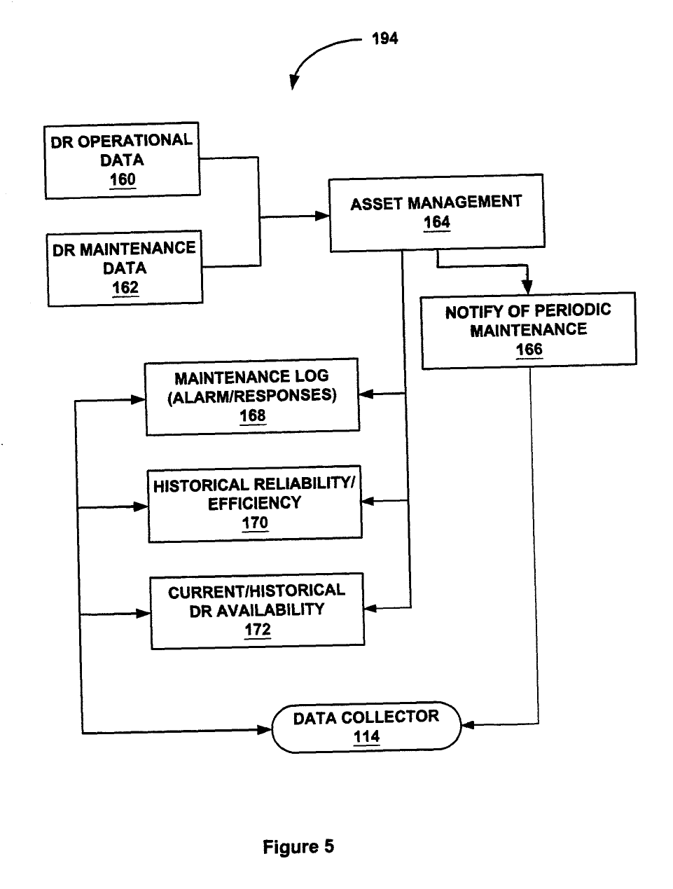

FIG. 5 illustrates an asset management subsystem 194 in accordance with an embodiment of the invention. In one embodiment of the invention inputs to the asset management module 164 include but are not limited to operational data 160 of the distributed resource or resources and maintenance data 162 of the distributed resource or resources. Additional inputs may include the connectivity status of the distributed resource, (whether the unit is turned on or turned off), the peak kilowatts (kW) of electricity that can be produced by the distributed resource, the total run time (hours of operation) of the distributed resource, the total number of on/off cycles of the distributed resource per day, the maximum on or off time per day, the operating time until the supply storage (e.g., fuel level, battery level) of the distributed resource is depleted, the preventative maintenance schedule for the distributed resource, operational data (if applicable), the rate of consumption of fuel for the distributed resource, the emission level of the distributed resource, the ambient, device, coolant/oil and exhaust temperature of the distributed resource, the revolutions per minute of the distributed device (if applicable), the fuel and oil pressure (if applicable), the output frequency of the distributed resource, and the electrical outputs of the distributed resource (in voltage, current and power).

Outputs from the asset management module 164 may include notifications that periodic maintenance is needed 166 and maintenance logs 168. Maintenance logs 168 may be accompanied by alarm notifications generated by the distributed device. Typically such alarms comprise a notice of failure, and may include information concerning the cause of the failure. Additional possible output may include the actual operations and maintenance costs of a distributed resource (not shown), the historical reliability and efficiency of the distributed resource or resources 170, and current and or historical availability of the distributed resource or resources 172.

For example, assume that distributed unit 1 has failed to start after a specified number of attempts to start the unit. The asset management subsystem may notify a service technician of the problem and log the failed start attempts to a trouble log for the unit. Preferably the maintenance log may be used to generate a historical probability of failed starts for the unit.

Results from the asset management module 164 may be sent to data collector 114. Alternately, the results may be sent to a user or to a dispatching system.

Reliability Subsystem

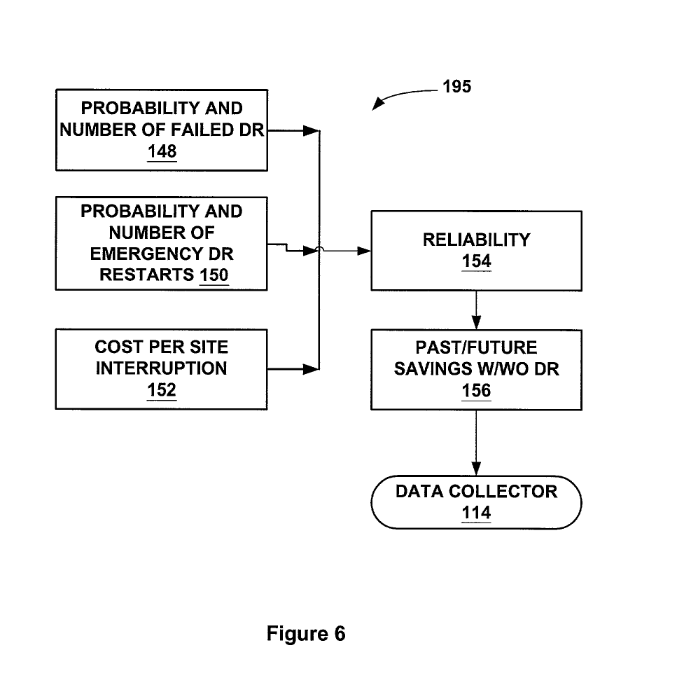

The reliability subsystem 195 preferably determines the present costs and projects the future costs of using the distributed resource to address reliability issues. The reliability subsystem 195 determines the benefit of the use of the distributed resource on the reliability of power at a site. FIG. 6 illustrates one embodiment of a reliability subsystem in accordance with the invention.

Inputs to the reliability module 154 include but are not limited to the probability of distributed resource emergency start 150 (for predicting future performance), the cost per site interruption 152, and the probability and number of distributed resource failed starts 148 (for predicting future performance).

Additional inputs may include the number of emergency DR starts for calculations based on historical performance, and the number of failed distributed resource starts for calculations based on historical performance.

Outputs include but are not limited to past and future savings using and not using distributed resources 156. For example, an interruption cost at a site may be determined to be one million dollars per interruption while the cost of operating the distributed resources is one hundred thousand dollars. If the site is expected to have four emergency starts and one of those emergency starts is expected to fail, the reliability application preferably determines the expected benefit of operating the distributed resources.

Results from the reliability module 154 may be sent to data collector 114. Alternately, the results may be sent to a user or to a dispatching system.

Network Analysis Subsystem

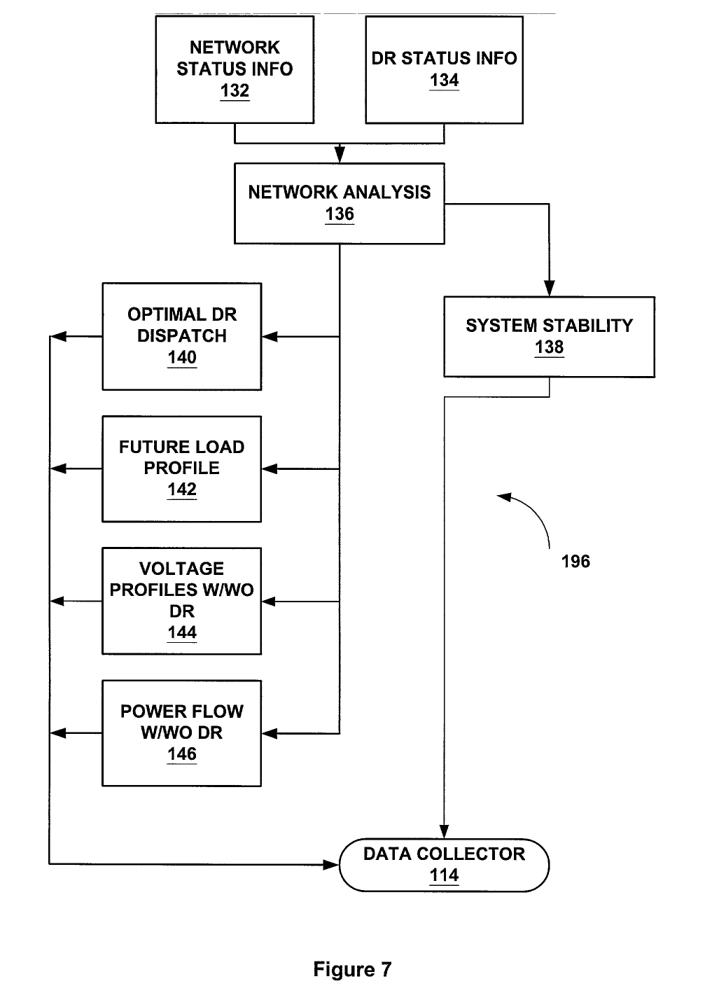

The network analysis subsystem 196, as shown in FIG. 7, is applied to a distribution/sub-transmission network and determines the operational effect of the distributed resources on a power system.

Applications within the network analysis subsystem 196 include power flow, network topology, state estimation, fault analysis, load forecasting, power system stability, volt/VAr control, power quality, optimal power flow and optimal resource scheduling. The network analysis subsystem 196 may be implemented in the central control or hybrid control embodiments and may be set to run upon user demand, periodically or may be triggered by an event.

Inputs to network analysis module 136 preferably include network information such as network status information 132, and distributed resources status information 134. Additional inputs may include but are not limited to maintenance schedules, load levels, DR dispatch levels and DR device information such as maximum and minimum output, response constraints, weather data and so on.

Outputs include but are not limited to line power flows with and without DR 146, voltage profiles with and without use of distributed resources 144, future load profiles 142 and optimal distributed resource dispatch 140 and system stability 138. Additional outputs may include bus voltages with/without DR, overloaded lines from DR operation or mis-operation, network status connectivity, stability of system depending on DR operation 138, and optional DR dispatch profile based on either economics, power system stability or voltage profile.

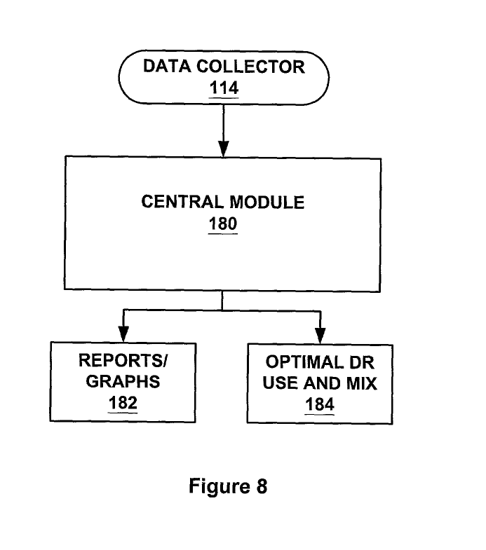

In one embodiment, as shown in FIG. 8, inputs are received by a data collection module 114 that validates the data and converts the data into a format acceptable by a central module 180 that processes this data. Central module 180 comprises in one embodiment one or more multiple artificial intelligence agents preferably including neural networks (responsible for pattern recognition), fuzzy logic (responsible for control schemes) and genetic algorithms (responsible for the optimization process). If central module 180 comprises artificial intelligence agents, certain inputs to the subsystems energy management 192, energy trading 193, asset management 194, reliability 195 and network analysis 196 preferably are received continuously from on-line sources, such as but not limited to the Internet and World Wide Web. Inputs received from on-line sources include but are not limited to fuel prices for distributed sources, electrical and thermal energy prices and weather data.

Alternatively, central module 180 may comprise a module that employs probabilistic techniques to project current and future data from historical data for fuel prices and electrical/thermal prices, weather data and the like, preferably based on three to five years of data. Forecasts are then run, based on the historical data in order to estimate a current price based on what happened in the past.

The probabilistic techniques module preferably includes the development of efficient (randomized) processes, the modeling of uncertainty in reactive systems, the quantification of system properties, and the evaluation of performance and reliability of systems. A probabilistic techniques module is useful when critical parameters are not known with certainty. A probabilistic techniques module may be used in process/cost model development, identification of input parameters of importance and output figures of merit, quantification of input uncertainty distributions, probabilistic simulation using personal computer based Monte Carlo techniques, and interpretation/summarization of results.

The dispatch plan generator subsystems 192, 193, 194, 195, 196 and central module 180 preferably include one or more built-in database engines. An exemplary engine may be an engine for utility rate tables, which are used in calculating the cost of electricity received from the grid. Another example may be a location-associated database engine, which may provide, for example, data concerning interconnection charges, load profiles for different customer categories, and so on. Receiving this data from an automated source enables user-provided inputs to be minimized.

The distributed resources fuel prices 104 and electrical thermal energy prices and trades 120 are supplied in one embodiment by historical data and in another embodiment by on-line sources including but not limited to the Internet and the World Wide Web. All inputs are collected, validated, and formatted and are passed to a central module 180 that uses probabilistic techniques or to multiple AI agents. Central module 180 returns one or more optimized solution plans 184, recommending the times of operations and percentages of different types of distributed resources units, (e.g., a solution plan may specify the use of 30% wind turbines, operated at 100% of capacity, 40% fuel cells operated at 100% of capacity and 30% micro-turbines operated at 50% of capacity) and preferably includes one or a plurality of options thereto. The user can choose from these recommendations a desired solution plan. Alternatively the user may provide a set of rules by which a decision would be made. The dispatch plan generator provides a customizable set of reports and graphs 182 for the selected solution plan.

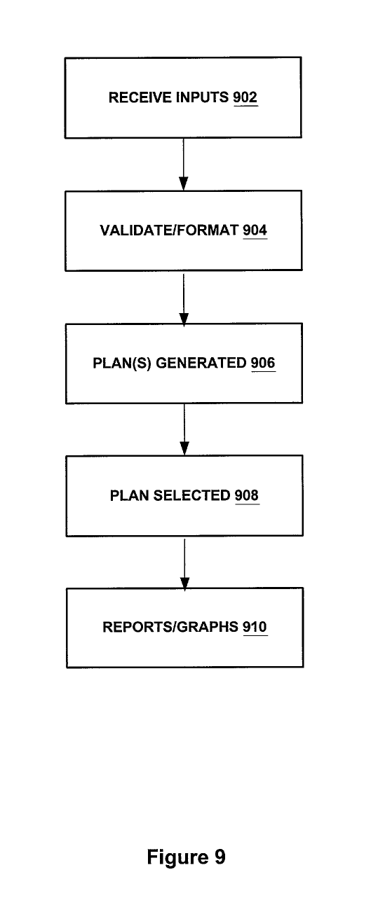

Referring now to FIG. 9, a process for generating an optimized dispatch plan is illustrated. At step 902, input to the subsystems is obtained. Input may be entered through a data input system by operators or may be generated by computerized means or may be received from on-line sources as previously discussed. At step 904 the data is validated and formatted. At step 906 a central module receives validated and formatted data and generates one or more optimized solution plans. At step 908, an optimized solution plan is selected. Either a user may select a desired solution or an optimized solution plan may be selected by using a set of rules input at step 902. At step 910, a set of reports and graphs is generated.

Reports and graphs preferably include reports and graphs concerning the optimized use and mix of distributed resources, energy savings/profits from trading, financial reports such as the return on investments, costs, etc., distributed resources maintenance schedules and records, the distributes resource units' performance and efficiency, network analysis reports with and without the algorithm solutions, comparison between different distributed resource technologies based on their performance under different scenarios and unit sizes. Reports preferably may include text and tables. Historical trends and the comparison of different solutions and options preferably are also provided.

Hence, a system and method in accordance with the present invention produces an optimized dispatch plan for distributed resources in electrical power systems is disclosed.

Illustrative Computing Environment

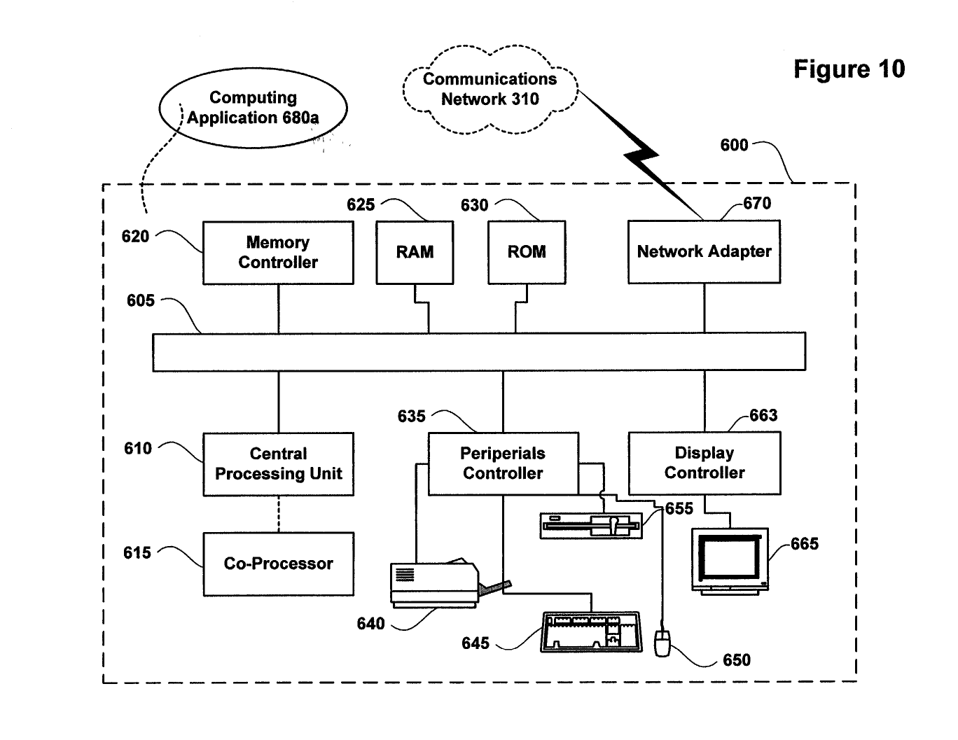

FIG. 10 depicts an exemplary computing system 600 in accordance with the invention. Computing system 600 executes an exemplary computing application 680a capable of controlling and managing a group of distributed resources so that the management of distributed resources is optimized in accordance with the invention. Exemplary computing system 600 is controlled primarily by computer-readable instructions, which may be in the form of software, wherever, or by whatever means such software is stored or accessed. Such software may be executed within central processing unit (CPU) 610 to cause data processing system 600 to do work. In many known workstations and personal computers central processing unit 610 is implemented by a single-chip CPU called a microprocessor. Coprocessor 615 is an optional processor, distinct from main CPU 610, that performs additional functions or assists CPU 610. One common type of coprocessor is the floating-point coprocessor, also called a numeric or math coprocessor, which is designed to perform numeric calculations faster and better than general-purpose CPU 610. Recently, however, the functions of many coprocessors have been incorporated into more powerful single-chip microprocessors.

In operation, CPU 610 fetches, decodes, and executes instructions, and transfers information to and from other resources via the computer's main data-transfer path, system bus 605. Such a system bus connects the components in computing system 600 and defines the medium for data exchange. System bus 605 typically includes data lines for sending data, address lines for sending addresses, and control lines for sending interrupts and for operating the system bus. An example of such a system bus is the PCI (Peripheral Component Interconnect) bus. Some of today's advanced busses provide a function called bus arbitration that regulates access to the bus by extension cards, controllers, and CPU 610. Devices that attach to these busses and arbitrate to take over the bus are called bus masters. Bus master support also allows multiprocessor configurations of the busses to be created by the addition of bus master adapters containing a processor and its support chips.

Memory devices coupled to system bus 605 include random access memory (RAM) 625 and read only memory (ROM) 630. Such memories include circuitry that allow information to be stored and retrieved. ROMs 630 generally contain stored data that cannot be modified. Data stored in RAM 625 can be read or changed by CPU 610 or other hardware devices. Access to RAM 625 and/or ROM 630 may be controlled by memory controller 620. Memory controller 620 may provide an address translation function that translates virtual addresses into physical addresses as instructions are executed. Memory controller 620 also may provide a memory protection function that isolates processes within the system and isolates system processes from user processes. Thus, a program running in user mode can access only memory mapped by its own process virtual address space; it cannot access memory within another process's virtual address space unless memory sharing between the processes has been set up.

In addition, computing system 600 may contain peripherals controller 635 responsible for communicating instructions from CPU 610 to peripherals, such as, printer 640, keyboard 645, mouse 650, and disk drive 655.

Display 665, which is controlled by display controller 663, is used to display visual output generated by computing system 600. Such visual output may include text, graphics, animated graphics, and video. Display 665 may be implemented with a CRT-based video display, an LCD-based flat-panel display, gas plasma-based flat-panel display, or a touch-panel. Display controller 663 includes electronic components required to generate a video signal that is sent to display 665.

Further, computing system 600 may contain network adaptor 670 which may be used to connect computing system 600 to an external communication network 310. Communications network 310 may provide computer users with means of communicating and transferring software and information electronically. Additionally, communications network 310 may provide distributed processing, which involves several computers and the sharing of workloads or cooperative efforts in performing a task. It will be appreciated that the network connections shown are exemplary and other means of establishing a communications link between the computers may be used.

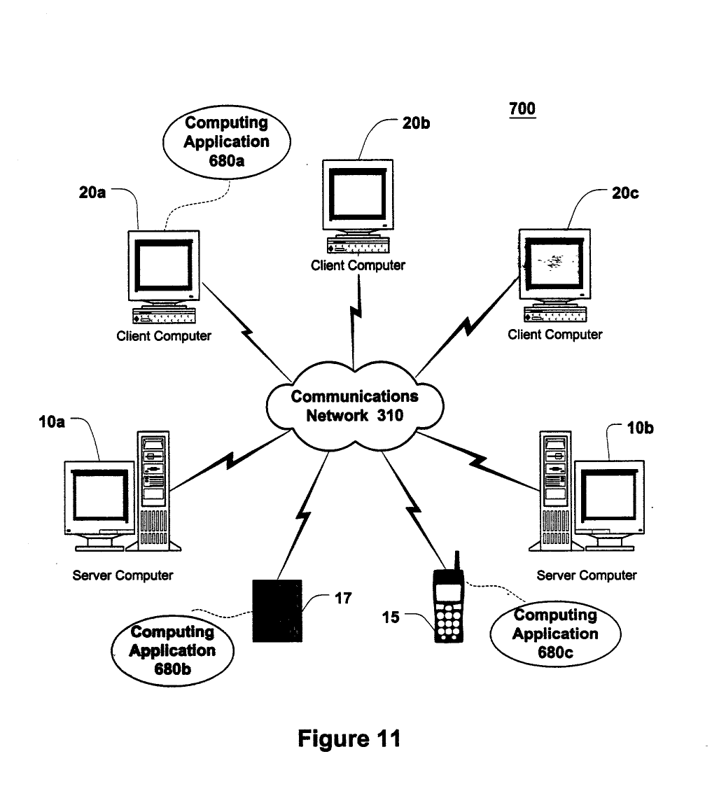

As noted above, the computer described with respect to FIG. 10 can be deployed as part of a computer network. In general, the above description applies to both server computers and client computers deployed in a network environment. FIG. 11 illustrates an exemplary network environment, with a server computer 10a, 10b in communication with client computers 20a, 20b, 20c via a communications network 310, in which the present invention may be employed.

As shown in FIG. 11, a number of servers 10a, 10b, etc., are interconnected via a communications network 310 (which may be a LAN, WAN, intranet or the Internet) with a number of client computers 20a, 20b, 20c, or computing devices, such as, mobile phone 15 and personal digital assistant 17. In a network environment in which communications network 310 is the Internet, for example, servers 10 can be Web servers with which clients 20 communicate via any of a number of known protocols, such as, hypertext transfer protocol (HTTP) or wireless application protocol (WAP), as well as other innovative communication protocols. Each client computer 20 can be equipped with computing application 680a to gain access to servers 10. Similarly, personal digital assistant 17 can be equipped with computing application 680b and mobile phone 15 can be equipped with computing application 680c to display and receive various data.

Thus, the present invention can be utilized in a computer network environment having client computing devices for accessing and interacting with the network and a server computer for interacting with client computers. However, the systems and methods of the present invention can be implemented with a variety of network-based architectures, and thus should not be limited to the example shown.

Although illustrated and described herein with reference to certain specific embodiments, the present invention is nevertheless not intended to be limited to the details shown. Rather, various modifications may be made in the details within the scope and range of equivalents of the claims without departing from the invention.

What is claimed is:

1. A method for generating an optimized dispatch plan for at least one of a plurality of distributed resources comprising:
receiving information associated with at least one of a plurality of distributed resources; and
generating at least one of a plurality of optimized dispatch plans for the at least one of a plurality of distributed resources based on the received information.

2. The method of claim 1, wherein generating the at least one optimized dispatch plan comprises using at least one of a plurality of artificial intelligence agents.

3. The method of claim 1, wherein generating the at least one optimized dispatch plan comprises using probabilistic techniques.

4. The method of claim 1, wherein the information associated with the at least one of a plurality of distributed resources comprises information associated with the energy output of the at least one distributed resource.

5. The method of claim 1, wherein the information associated with the at least one of a plurality of distributed resources comprises information associated with a price at which energy is sold.

6. The method of claim 1, wherein the information associated with the at least one of a plurality of distributed resources comprises information associated with maintenance of the at least one distributed resource.

7. The method of claim 1, wherein the information associated with the at least one of a plurality of distributed resources comprises information associated with reliability of the at least one distributed resource.

8. The method of claim 1, wherein the information associated with the at least one of a plurality of distributed resources comprises information associated with efficiency of the at least one distributed resource.

9. The method of claim 1, wherein the information associated with the at least one of a plurality of distributed resources comprises information associated with availability of the at least one distributed resource.

10. The method of claim 1, wherein the information associated with the at least one of a plurality of distributed resources comprises information associated with cost savings associated with the use of the at least one distributed resource.

11. The method of claim 1, wherein the information associated with the at least one of a plurality of distributed resources comprises information associated with power line flows associated with the use of the at least one distributed resource.

12. The method of claim 1, wherein the information associated with the at least one of a plurality of distributed resources comprises information associated with voltage profiles.

13. The method of claim 1, further comprising s electing one of the plurality of dispatch plans based on a plurality of rules.

14. The method of claim 1, further comprising receiving user input and selecting one of the plurality of dispatch plans based on the user input.

15. The method of claim 1, wherein the at least one optimized dispatch plan is based on economic considerations.

16. The method of claim 1, wherein the at least one optimized dispatch plan is based on engineering considerations.

17. A computer-implemented system for generating an optimized dispatch plan for distributed resources comprising:
a data collector that collects information associated with at least one of a plurality of distributed resources;
a data verifier that verifies said information received from said data collector and generates verified information;
a data formatter that receives said verified information from said data verifier and formats said verified information;
a plan generator that receives said verified and formatted information and generates an optimized dispatch plan for distributed resources.

18. The system of claim 15, wherein the plan generator utilizes probabilistic techniques.

19. The system of claim 15, wherein the plan generator comprises at least one of a plurality of artificial intelligence agents.

20. A computer-readable medium comprising computer-readable instructions for:
receiving information associated with at least one of a plurality of distributed resources; and
generating at least one of a plurality of optimized dispatch plans for the at least one of a plurality of distributed resources based on the received information.
